(19) United States
(12) Patent Application Publication
(10) Pub. No.: US 2025/0141071 A1
(43) Pub. Date: May 1, 2025

(54) BATTERY

(71) Applicant: TOYOTA JIDOSHA KABUSHIKI KAISHA, Toyota-shi (JP)

(72) Inventors: Kota OHATA, Toyota-shi (JP); Masahiro ISHIZUKA, Toyota-shi (JP); Hajime HASEGAWA, Aichi-gun (JP); Mitsuru TATEISHI, Toyota-shi (JP); Norihiro OSE, Nagoya-shi (JP); Masashi CHIHARA, Nagoya-shi (JP)

(21) Appl. No.: 18/824,915

(22) Filed: Sep. 5, 2024

(30) Foreign Application Priority Data
Nov. 1, 2023 (JP) 2023-187953

(51) Int. Cl. H01M 50/586; H01M 50/105; H01M 50/59

(52) U.S. Cl. CPC H01M 50/586; H01M 50/105; H01M 50/59

(57) ABSTRACT

A battery, includes: electrode body including positive and negative electrodes being alternately layered in a first direction with separator provided therebetween. The positive electrode current collector has a first burr and the negative electrode current collector has a second burr. In the battery, either the following (A) or (B) is satisfied: (A) plural first burrs do not include a pair of first burrs in which protrusion directions of adjacent first burrs differ, and plural second burrs do not include a pair of second burrs in which protrusion directions of adjacent second burrs differ; or (B) plural first burrs include only one pair of first burrs in which protrusion directions of adjacent first burrs differ, and plural second burrs include only one pair of second burrs in which protrusion directions of adjacent second burrs differ.

### CROSS-REFERENCE TO RELATED APPLICATION

This application claims priority under 35 USC 119 from Japanese Patent Application No. 2023-187953, filed on Nov. 1, 2023, the disclosure of which is incorporated by reference herein.

### BACKGROUND

### Technical Field

The present disclosure relates to a battery.

### Related Art

Japanese Patent Application Laid-open (JP-A) No. 2019-53917, discloses an electrochemical device (hereinafter, also referred to as a “battery”). The battery includes an electrode body in which a positive electrode, a negative electrode, and a separator are layered in a thickness direction, such that the separator is positioned between the positive electrode and the negative electrode. The positive electrode has a positive electrode current collector and a positive electrode active material layer provided on the positive electrode current, collector. The negative electrode has a negative electrode current collector, and a specific negative electrode active material layer provided on the negative electrode current collector. The positive electrode current collector has a positive electrode current collector exposed portion. The positive electrode current collector exposed portion is positioned at an end portion of the positive electrode, and the positive electrode current collector is exposed at this portion. The positive electrode current collector exposed portion is provided so that a portion thereof overlaps with the negative electrode, with the separator interposed therebetween, in plan view. In the electrode body, an interval retaining portion is provided at an end portion at which the positive electrode current collector exposed portion is positioned, at a portion at which an end portion of the positive electrode current collector exposed portion positioned on the outer peripheral side of the electrode body, and the negative electrode, overlap each with other in plan view. The interval retaining portion has electrical insulation. The interval retaining portion is provided between the positive electrode current collector exposed portion and the separator, so as to maintain an interval between the positive electrode current collector exposed portion and the separator in the layering direction.

The positive electrode current collector and the negative electrode current collector are usually cut to predetermined dimensions. In this case, burrs may be generated at the respective ends of the positive electrode current collector and the negative electrode current collector, protruding in the thickness direction thereof. In JP-A No. 2019-53917, no investigation is made of the arrangement of each of the positive electrode current collector and the negative electrode current collector in view of the protrusion direction of the burrs of each of the positive electrode current collector and the negative electrode current collector. Therefore, there is a risk that the positive electrode current collector and the negative electrode current collector physically contacts due to burrs, as a result of which short circuiting may occur in the electrode body.

### SUMMARY

The present disclosure provides a battery that may suppress the occurrence of short circuiting.

A first aspect of the present disclosure is a battery including: an electrode body including plural positive electrodes each including a positive electrode current collector, and plural negative electrodes each including a negative electrode current collector, the plural positive electrodes and the plurality of negative electrodes being alternately layered in a first direction with a separator provided therebetween; a laminate exterior body accommodating the electrode body; a first tab projecting from the laminate exterior body toward one side in a second direction that is orthogonal to the first direction, the first tab electrically connected to a plurality of the positive electrode current collectors; and a second tab projecting from the laminate exterior body toward another side in the second direction, the second tab being electrically connected to plural negative electrode current collectors, wherein the positive electrode current collector has a first burr projecting toward the first direction at an edge at a side of the second tab, wherein the negative electrode current collector has a second burr projecting toward the first direction at an edge at a side of the first tab, and wherein either the following (A) or (B) is satisfied: (A) plural first burrs do not include a pair of first burrs in which protrusion directions of adjacent first burrs differ, and plural second burrs do not include a pair of second burrs in which protrusion directions of adjacent second burrs differ; or (B) plural first burrs include only one pair of first burrs in which protrusion directions of adjacent first burrs differ, and plural second burrs include only one pair of second burrs in which protrusion directions of adjacent second burrs differ.

Here, “Laminate exterior body” refers to a case made of a laminate sheet. “Laminate sheet” refers to a sheet having at least a metal layer, a first resin layer layered on one main surface of the metal layer, and a second resin layer layered on the other main surface of the metal layer.

Hereinafter, in a case in which the positive electrode current collector and the negative electrode current collector are not distinguished from each other, the positive electrode current collector or the negative electrode current collector is simply referred to as a “current collector”. In a case in which the first burr and the second burr are not distinguished from each other, the first burr or the second burr is simply referred to as a “burr”. In a case in which the first tab and the second tab are not distinguished from each other, the first tab or the second tab is simply referred to as a “tab”.

The battery of the first aspect satisfies (A) or (B). In a case in which the battery of the first aspect satisfies (A), in a battery including a laminate exterior body having a single-cup structure, the current collectors can be regularly arranged so that the protrusion directions of the burrs are aligned. As a result, adjacent positive electrode current collectors and negative electrode current collectors are less likely to physically contact each other than in a configuration in which current collectors are irregularly arranged. As a result, in the battery of the first aspect, the occurrence of short circuiting may be suppressed. In a case in which the battery of the first aspect satisfies (B), in batteries including a laminate exterior body having a double-cup structure, the position of a pair of burrs in the first direction can be adjusted to the same position as the positions of the tabs in the first direction. As a result, the current collectors are regularly arranged so that the protrusion directions of plural burrs positioned on one side of the pair of burrs in the first direction are aligned in a specific direction. Furthermore, the current collectors can be regularly arranged so that the protrusion directions of plural burrs positioned on the other side of the pair of burrs in the first direction are aligned in an opposite direction to the specific direction. As a result, adjacent positive electrode current collectors and negative electrode current collectors are less likely to physically contact each other than in a configuration in which current collectors are irregularly arranged. As a result, in the battery of the first aspect, the occurrence of short circuiting may be suppressed.

Here, “laminate exterior body having a single-cup structure” refers to a single laminate exterior body having a bending line, one cup portion (recessed portion) capable of housing the entire electrode body, and a flat portion, in which the flat portion covers the recess as a result of bending along the bending line. Further, “double-cup structure” refers to a single laminate exterior body having a bending line, one first cup portion (recessed portion) capable of housing a portion of an electrode body, and one second cup portion (recessed portion) capable of housing a portion of an electrode body, which can accommodate the entire electrode body in a space formed by overlapping the first cup portion and the second cup with each other by bending along the bending line.

In a second aspect of the present disclosure, in the first aspect, may further comprise plural electrically insulating members covering each of the first burrs and the second burrs.

In the battery of the second aspect, as compared to a configuration in which the electrically insulating members are not provided, the first burr of the positive electrode current collector becomes less likely to physically contact the negative electrode current collector, and the second burr of the negative electrode current collector is less likely to physically contact the positive electrode current collector. As a result, in the battery of the second aspect, the occurrence of short circuiting may more reliably suppressed.

In third aspect of the present disclosure, in the above first or the second aspect, foregoing (A) may be satisfied.

In fourth aspect of the present disclosure, in the above first or the second aspect, foregoing (B) may be satisfied.

According to the present disclosure, a battery is provided in which the occurrence of short circuiting is suppressed.

### BRIEF DESCRIPTION OF THE DRAWINGS

Exemplary embodiments will be described in detail based on the following figures, wherein:

FIG. 1 is a front view of a battery according to a first exemplary embodiment of the present disclosure;

FIG. 2 is a cross-sectional view along line II-II in FIG. 1;

FIG. 3 is a front view of a battery according to a second exemplary embodiment of the present disclosure; and

FIG. 4 is a cross-sectional view along line IV-IV in FIG. 3.

### DETAILED DESCRIPTION

Exemplary embodiments of the present disclosure will be described in detail below. These descriptions and examples illustrate exemplary embodiments and are not intended to limit the scope of the exemplary embodiments. In the present disclosure, a combination of two or more preferred embodiments is a more preferred embodiment. In the present disclosure, a numerical range expressed using “to” means a range in which the numerical values described before and after “to” are included as the lower limit value and the upper limit value. In numerical ranges given in a stepwise manner in the present disclosure, the upper limit or lower limit given in one numerical range may be replaced with the upper limit or lower limit of another numerical range described in a stepwise manner. In the numerical ranges set forth in the present disclosure, the upper or lower limit of a numerical range may be replaced with a value set forth in the examples.

Exemplary embodiments of the battery of the present disclosure will be described below with reference to the drawings. In the drawings, the same or corresponding portions are denoted by the same reference numerals, and description thereof will not be repeated.

### (1) First Exemplary Embodiment

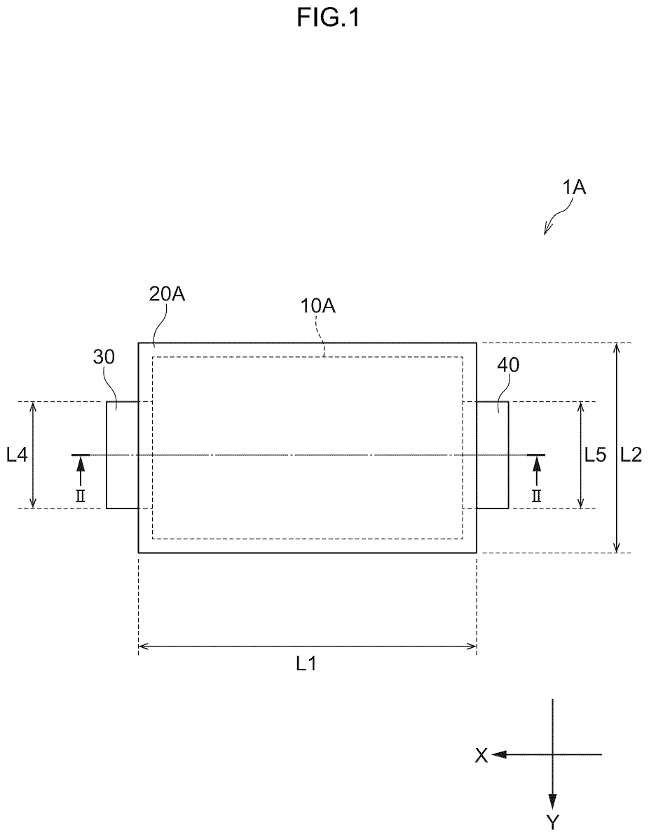

As shown in FIG. 1, a battery 1A of a first exemplary embodiment of the present disclosure is provided with an electrode body 10A, a laminate exterior body 20A, a positive electrode tab 30 which is an example of a first tab, a negative electrode tab 40 which is an example of a second tab, a non-aqueous electrolyte (not illustrated), and plural electrically insulating members 50. The battery 1A has a rectangular parallelepiped shape.

In the present exemplary embodiment, the longitudinal direction of the main surface of the battery 1A is defined as the X-axis direction, the transverse direction of the main surface of the battery 1A is defined as the Y-axis direction, and the thickness direction of the battery 1A is defined as the Z-axis direction. The X-axis, the Y-axis, and the Z-axis are respectively orthogonal to each other. The Z-axis is an example of a first direction. The X-axis is an example of a second direction. The Y-axis is an example of a third direction. Note that these orientations do not limit the orientation of the battery of the present disclosure during use.

The laminate exterior body 20A houses the electrode body 10A, the non-aqueous electrolyte solution, and the electrically insulating members 50. The positive electrode tab 30 protrudes from the laminate exterior body 20A in the X-axis positive direction. The negative electrode tab 40 protrudes from the laminate exterior body 20A in the X-axis negative direction.

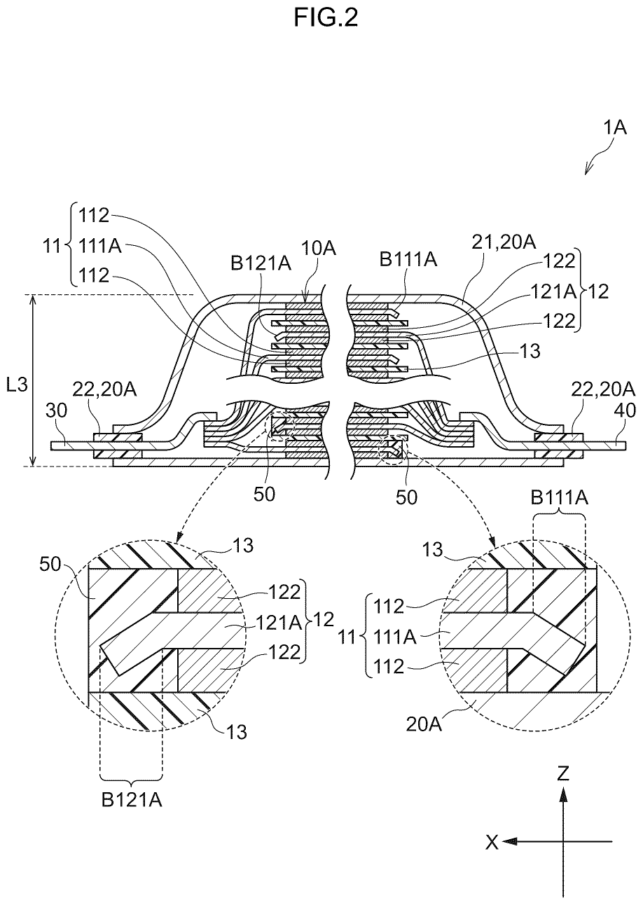

The length L1 of the battery 1A in the X-axis direction (see FIG. 1) is, for example, 530 mm to 600 mm. The length L2 of the battery 1A in the Y-axis direction (see FIG. 1) is, for example, 80 mm to 110 mm. The length L3 of the battery 1A in the Z-axis direction (see FIG. 2) is, for example, 7.0 mm to 9.0 mm.

### (1.1) Electrode Body

The structure of the electrode body 10A is layer-type. As shown in FIG. 2, the electrode body 10A includes plural positive electrodes 11, plural negative electrodes 12, and plural separators 13. In the electrode body 10A, a positive electrode 11 and a negative electrode 12 are alternately layered along the Z-axis direction via a separator 13.

The number of each of the positive electrode 11, the negative electrode 12, and the separator 13 is not particularly limited, and is appropriately selected in accordance with the use of the battery 1A.

### (1.1.1) Positive Electrode

The positive electrode 11 has a positive electrode current collector 111A (for example, aluminum foil) and a positive electrode active material layer 112 supported on both surfaces of the positive electrode current collector 111A. The positive electrode active material layer 112 contains a positive electrode active material. The positive electrode active material releases lithium ions into or occludes lithium ions from the non-aqueous electrolyte. The positive electrode active material may be a known positive electrode active material (for example, LiNiO₂ or LiNi_{1/3}Co_{1/3}Mn_{1/3}O₂). The positive electrode active material layer 112 may further contain a known conductive material (for example, carbon black), trilithium phosphate, and a known binder (for example, polyvinylidene fluoride).

In the first exemplary embodiment, the plural positive electrode current collectors included in the electrode body 10A are formed from only the positive electrode current collector 111A. The positive electrode current collector 111A has a positive electrode burr B111A, which is an example of a first burr, at an edge on the side of the negative electrode tab 40. The positive electrode burr B111A protrudes toward the negative direction in the Z-axis direction. The positive electrode burrs of the plural positive electrode current collectors included in the electrode body 10A do not include a pair of positive electrode burrs in which the protrusion directions of adjacent positive electrode burrs are different.

### (1.1.2) Negative Electrode

The negative electrode 12 has a negative electrode current collector 121A (for example, copper foil) and a negative electrode active material layer 122 supported on both surfaces of the negative electrode current collector 121A. The negative electrode active material layer 122 contains a negative electrode active material. In conjunction with charging and discharging, the negative electrode active material occludes lithium ions, which are charge carriers, from the non-aqueous electrolyte and releases them into the non-aqueous electrolyte. The negative electrode active material may be any known negative electrode active material (such as artificial graphite or lithium-alloy (for example, LiXM, where M is C, Si, Sn, Sb, Al, Mg, Ti, Bi, Ge, Pb or P, and X is a natural number)). The negative electrode active material layer 122 may further contain a known binder (for example, a styrene-butadiene copolymer).

In the first exemplary embodiment, the plural negative electrode current collectors included in the electrode body 10A are formed from only the negative electrode current collector 121A. The negative electrode current collector 121A has a negative electrode burr B121A, which is an example of a second burr, at an edge on the side of the positive electrode tab 30. The negative electrode burr B121A protrudes in the negative direction in the Z-axis direction. In the first exemplary embodiment, the negative electrode burrs of the plural negative electrode current collectors included in the electrode body 10A do not include a pair of negative electrode burrs in which the protrusion directions of adjacent negative electrode burrs are different.

### (1.1.3) Separator

The separator 13 electrically insulates the positive electrode 11 and the negative electrode 12 and provides a lithium ion transfer path between the positive electrode active material layer 112 and the negative electrode active material layer 122. Examples of the separator 13 include a porous film. Examples of the material of the porous film include polyethylene and polypropylene. The separator 13 may have a single-layer structure or a multilayer structure.

### (1.2) Laminate Exterior Body

The laminate exterior body 20A covers the electrode body 10A and seals the electrode body 10A and the non-aqueous electrolyte together with the positive electrode tab 30 and the negative electrode tab 40. In the first exemplary embodiment, the laminate exterior body 20A has a single-cup configuration. The laminate exterior body 20A is configured such that each of the positive electrode tab 30 and the negative electrode tab 40 is positioned at an end portion at the Z-axis negative direction side of the laminate exterior body 20A. The laminate exterior body 20A has one laminate sheet 21 and plural tab films 22. Each of the plural tab films 22 is welded to the positive electrode tab 30 or the negative electrode tab 40 and to the laminate sheet 21.

### (1.2.1) Laminate Sheet

The laminate sheet 21 has a metal layer, an inner resin layer, and an outer resin layer. The inner resin layer is layered on the surface of the metal layer on the side of the electrode body 10A. The outer resin layer is layered on the surface of the metal layer at the opposite side from the electrode body 10A. The metal layer blocks gas (for example, moisture or air) outside of the battery 1A and inside of the battery 1A from entering and leaving. The material of the metal layer is a metal (for example, aluminum). The inner resin layer electrically insulates the electrode body 10A, the positive electrode tab 30, and the negative electrode tab 40 from the metal layer. The inner resin layer may contain a thermoplastic resin. The outer resin layer improves the durability of the laminate sheet 21. The outer resin layer may contain a thermoplastic resin. Examples of the thermoplastic resin of each of the inner resin layer and the outer resin layer include olefinic resins (for example, polypropylene and polyethylene), polyvinyl chloride, and polyvinylidene chloride.

### (1.2.2) Tab Film

The tab film 22 has a function of electrically insulating the laminate sheet 21 from the positive electrode tab 30 and the negative electrode tab 40, and a function of connecting the laminate sheet 21 to the positive electrode tab 30 and the negative electrode tab 40. The tab film 22 contains a thermoplastic resin. Examples of the thermoplastic resin of the tab film 22 include the same resins as those exemplified as the thermoplastic resins of the inner resin layer and the outer resin layer.

### (1.3) Positive Electrode Tab

The positive electrode tab 30 is electrically connected to the plural positive electrode current collectors 111A. Examples of the material of the positive electrode tab 30 include a metal (for example, stainless steel (SUS)). The length L4 of the positive electrode tab 30 in the Y-axis direction (see FIG. 1) is, for example, 40 mm to 50 mm.

### (1.4) Negative Electrode Tab

The negative electrode tab 40 is electrically connected to the plural negative electrode current collectors 121A. Examples of the material of the negative electrode tab 40 include a metal (for example, stainless steel (SUS)). The length L5 of the negative electrode tab 40 in the Y-axis direction (see FIG. 1) is, for example, 40 mm to 50 mm.

### (1.5) Non-Aqueous Electrolyte

The battery 1A is provided with a non-aqueous electrolyte. The non-aqueous electrolyte is housed in the laminate exterior body 20A together with the electrode body 10A. It is sufficient that the non-aqueous electrolyte be a solution in which a support salt as an electrolyte (for example, LiPF₆) is dissolved or dispersed in a non-aqueous solvent (for example, ethyl carbonate). The non-aqueous electrolyte may contain various additives (such as lithium bis(oxalato) borate).

### (1.6) Electrically Insulating Member

The battery 1A is provided with plural electrically insulating members 50. In the first exemplary embodiment, the plural electrically insulating members 50 cover the positive electrode tab 30 of the positive electrode current collector 111A, positioned furthest toward the Z-axis negative direction side, and the negative electrode tab 40 of the negative electrode current collector 121A, positioned furthest toward the Z-axis negative direction side. The electrically insulating members 50 contain a thermoplastic resin. Examples of the thermoplastic resin of the electrically insulating member 50 include the same resins as those exemplified as the thermoplastic resins of the inner resin layer and the outer resin layer.

### (1.7) Use Application

The use of the battery 1A is not particularly limited, and examples thereof include a power supply for a vehicle, a power supply for an information processing apparatus (for example, a personal computer or a smartphone), and a power supply for power storage.

### (1.8) Mechanism

As described with reference to FIGS. 1 and 2, a battery 1A is provided with an electrode body 10A, a laminate exterior body 20A, a positive electrode tab 30, and a negative electrode tab 40. The battery 1A satisfies (A) below.

(A) The plural positive electrode burrs do not include a pair of positive electrode burrs having different protrusion directions in adjacent positive electrode burrs, and the plural negative electrode burrs do not include a pair of negative electrode burrs having different protrusion directions in adjacent negative electrode burrs.

As a result, the positive electrode current collectors 111A are regularly arranged so that the protrusion direction of the positive electrode burrs B111A is aligned. As a result, it becomes less likely that adjacent positive electrode current collectors 111A and negative electrode current collectors 121A will physically contact each other than in a configuration in which positive electrode current collectors 111A are irregularly arranged. The same applies to the negative electrode current collector 121A. As a result, in the battery 1A, the occurrence of short circuiting may be suppressed.

As described with reference to FIGS. 1 and 2, the battery 1A further comprises an electrically insulating member 50. As a result, in the battery 1A, it becomes less likely that the positive electrode burr B111A of the positive electrode current collector 111A will physically contact the negative electrode current collector 121A than in a configuration in which the electrically insulating member 50 is not provided, and the negative electrode burr B121A of the negative electrode current collector 121A is less likely to physically contact the positive electrode current collector 111A. As a result, in the battery 1A, the occurrence of short circuiting may more reliably suppressed.

### (2) Second Exemplary Embodiment

The battery 1B of a second exemplary embodiment of the present disclosure is the same as the battery 1A of the first exemplary embodiment except that, mainly, the laminate exterior body has a double cup structure, and the plural burrs include a pair of burrs in which the protrusion directions of the burrs are different.

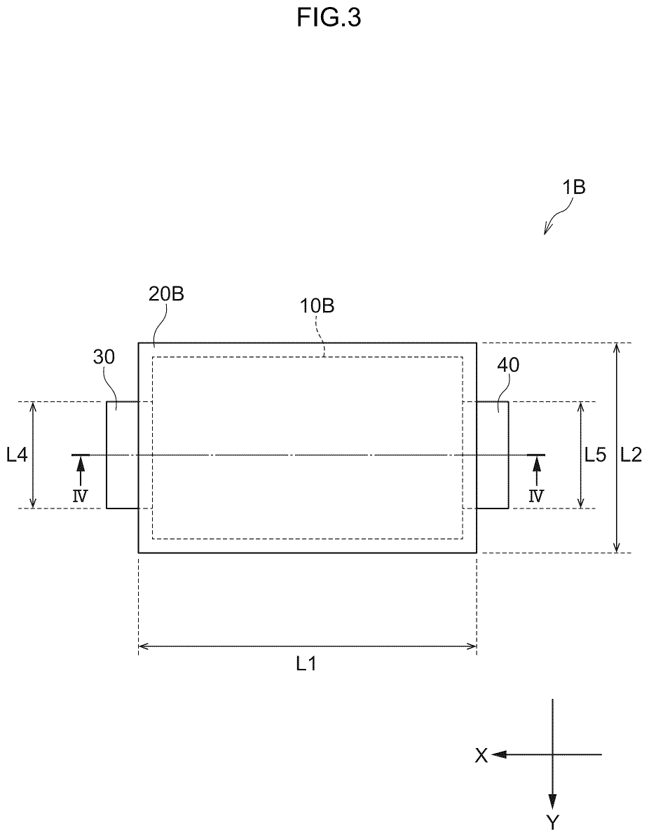

As shown in FIG. 3, the battery 1B is provided with an electrode body 10B, a laminate exterior body 20B, a positive electrode tab 30, a negative electrode tab 40, a non-aqueous electrolyte (not shown), and plural electrically insulating members 50.

### (2.1) Electrode Body

The electrode body 10B is the same as the electrode body 10A except that the plural burrs include a pair of burrs having different protrusion directions.

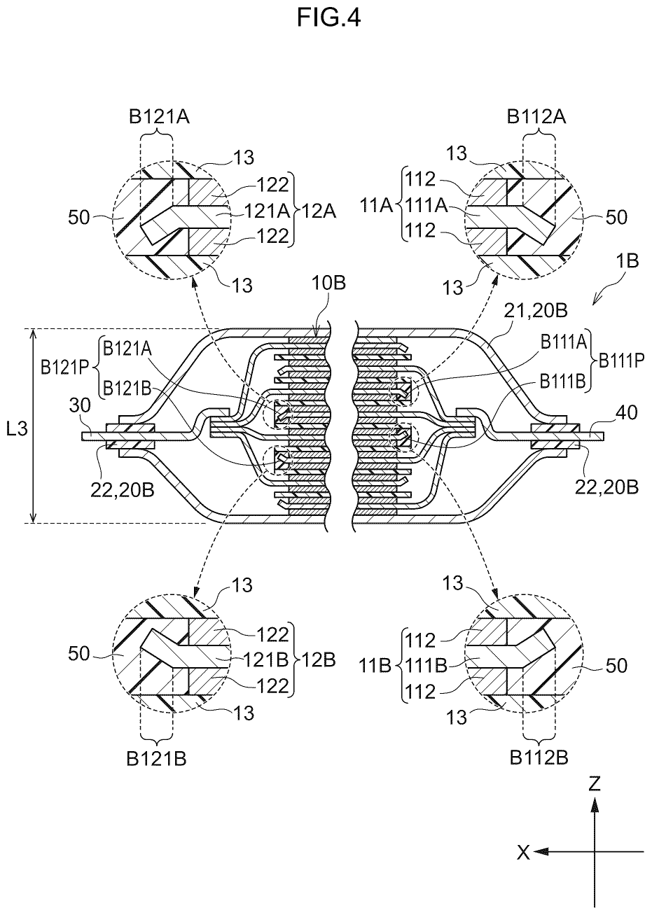

In the second exemplary embodiment, the plural positive electrode current collectors included in the electrode body 10B have plural positive electrode current collectors 111A and plural positive electrode current collectors 111B. The positive electrode current collector 111B has a positive electrode burr B111B. The positive electrode burr B111B protrudes toward the positive direction in the Z-axis direction. The plural positive electrode current collectors 111A are positioned on the positive direction side of the negative electrode tab 40 in the Z-axis direction. The plural positive electrode current collectors 111B are positioned on the negative direction side of the negative electrode tab 40 in the Z-axis direction. In other words, in the second exemplary embodiment, in the vicinity of the position of the negative electrode tab 40 in the Z-axis direction, only one pair of positive electrode burrs B111P (see FIG. 4) is included in which the protrusion directions of adjacent positive electrode burrs are different. The pair of positive electrode burrs B111P includes a positive electrode burr B111A of the positive electrode current collector 111A and a positive electrode burr B111B of the positive electrode current collector 111B.

In the second exemplary embodiment, the plural negative electrode current collectors included in the electrode body 10B have plural negative electrode current collectors 121A and plural negative electrode current collectors 121B. The negative electrode current collector 121B has a negative electrode burr B121B. The negative electrode burr B121B protrudes in the positive direction in the Z-axis direction. The plural negative electrode current collectors 121A are positioned on the positive direction side of the positive electrode tab 30 in the Z-axis direction. The plural negative electrode current collectors 121B are positioned on the negative direction side of the positive electrode tab 30 in the Z-axis direction. In other words, in the second exemplary embodiment, in the vicinity of the position of the positive electrode tab 30 in the Z-axis direction, only one pair of positive electrode burrs B111P (see FIG. 4) is included in which the protrusion directions of adjacent negative electrode burrs are different. The pair of negative electrode burrs B121P includes a negative electrode burr B121A of the negative electrode current collector 121A and a negative electrode burr B121B of the negative electrode current collector 121B (see FIG. 4).

### (2.2) Laminate Exterior Body

The laminate exterior body 20B is the same as the laminate exterior body 20A of the first exemplary embodiment except that it has a double-cup structure. The laminate exterior body 20B is configured so that each of the positive electrode tab 30 and the negative electrode tab 40 are positioned at the center portion of the laminate exterior body 20A in the Z-axis direction.

### (2.3) Electrically Insulating Member

The battery 1B is provided with plural electrically insulating members 50. In the second exemplary embodiment, plural electrically insulating members 50 cover the positive electrode tab 30 of the two positive electrode current collectors 111A positioned in the center portion in the Z-axis direction (the two positive electrode current collectors 111A closest to the negative electrode tab 40 in the Z-axis direction), and the negative electrode tab 40 of the negative electrode current collectors 121A positioned in the center portion in the Z-axis direction (the two negative electrode current collectors 121A closest to the positive electrode tab 30 in the Z-axis direction).

### (2.4) Mechanism

As described with reference to FIGS. 3 and 4, the battery 1B is provided with the electrode body 10B, the laminate exterior body 20B, the positive electrode tab 30, and the negative electrode tab 40. The plural positive electrode current collectors included in the electrode body 10B have plural positive electrode current collectors 111A and plural positive electrode current collectors 111B. The plural negative electrode current collectors included in the electrode body 10B have plural negative electrode current collectors 121A and plural negative electrode current collectors 121B. The battery 1B satisfies (B) below.

(B) Plural positive electrode burrs contain only one pair of positive electrode burrs B111P, and plural negative electrode burrs contain only one pair of negative electrode burrs B121P.

As a result, the positive electrode current collectors 111A are regularly arranged so that the protrusion directions of the plural positive electrode burrs B111A positioned at the Z-axis positive direction side with respect to the pair of positive electrode burrs B111P are aligned in the Z-axis negative direction. Furthermore, the positive electrode current collectors 111B can be regularly arranged so that the protrusion directions of the plural positive electrode burrs B111B positioned in the Z-axis negative direction with respect to the pair of positive electrode burrs B111P are aligned in the Z-axis positive direction. The negative electrode current collectors 121A are regularly arranged so that the protrusion directions of the plural negative electrode burrs B121A positioned on the Z-axis positive direction side with respect to the pair of negative electrode burrs B121P are aligned in the Z-axis negative direction. Furthermore, the negative electrode current collectors 121B are regularly arranged so that the protrusion directions of the plural negative electrode burrs B121B positioned in the Z-axis negative direction with respect to the pair of negative electrode burrs B121P are aligned in the Z-axis positive direction. Therefore, adjacent positive electrode current collectors and negative electrode current collectors are less likely to physically contact each other than in a configuration in which the positive electrode current collector 111A, the positive electrode current collector 111B, the negative electrode current collector 121A, and the negative electrode current collector 121B are each irregularly arranged. As a result, in the battery 1B, the occurrence of short circuiting may be suppressed.

As described with reference to FIGS. 3 and 4, the battery 1B further comprises electrically insulating members 50. As a result, in the battery 1B, it becomes less likely that the positive electrode burr of the positive electrode current collector will physically contact the negative electrode current collector than in a configuration in which the electrically insulating members 50 are not provided, and the negative electrode burr of the negative electrode current collector is less likely to physically contact the positive electrode current collector. As a result, in the battery 1B, the occurrence of short circuiting may be more reliably suppressed.

### (3) Variant Example

While each of the battery 1A and the battery 1B is provided with plural electrically insulating members 50, the present disclosure is not limited thereto. The battery of the present disclosure does not need to include plural electrically insulating members 50.

What is claimed is:

1. A battery, comprising:
an electrode body including a plurality of positive electrodes each including a positive electrode current collector, and a plurality of negative electrodes each including a negative electrode current collector, the plurality of positive electrodes and the plurality of negative electrodes being alternately layered in a first direction with a separator provided therebetween;
a laminate exterior body accommodating the electrode body;
a first tab projecting from the laminate exterior body toward one side in a second direction that is orthogonal to the first direction, the first tab electrically connected to a plurality of the positive electrode current collectors; and
a second tab projecting from the laminate exterior body toward another side in the second direction, the second tab being electrically connected to a plurality of the negative electrode current collectors,
wherein the positive electrode current collector has a first burr projecting toward the first direction at an edge at a side of the second tab,
wherein the negative electrode current collector has a second burr projecting toward the first direction at an edge at a side of the first tab, and
wherein either the following (A) or (B) is satisfied:
(A) plural first burrs do not include a pair of first burrs in which protrusion directions of adjacent first burrs differ, and plural second burrs do not include a pair of second burrs in which protrusion directions of adjacent second burrs differ; or
(B) plural first burrs include only one pair of first burrs in which protrusion directions of adjacent first burrs differ, and plural second burrs include only one pair of second burrs in which protrusion directions of adjacent second burrs differ.

2. The battery of claim 1, further comprising a plurality of electrically insulating members covering each of the first burrs and the second burrs.

3. The battery of claim 1, wherein (A) is satisfied.

4. The battery of claim 1, wherein (B) is satisfied.
